(19) United States
(12) Patent Application Publication
(10) Pub. No.: US 2016/0203483 A1
(43) Pub. Date: Jul. 14, 2016

(54) Personal Account Authorization Controls

(71) Applicant: TOTAL SYSTEM SERVICES, INC., Columbus, GA (US)

(72) Inventors: Paul Bridgewater, Columbus, GA (US); Christen J. Colson, Cumming, GA (US)

(21) Appl. No.: 14/914,192

(22) PCT Filed: Aug. 26, 2014
(86) PCT No.: PCT/US14/52747

§ 371 Date: Feb. 24, 2016

Related U.S. Application Data
(60) Provisional application No. 61/869,936, filed on Aug. 26, 2013.

(51) Int. Cl. G06Q 20/40

(52) U.S. Cl. CPC G06Q 20/401; G06Q 20/405; G06Q 2220/00

(57) ABSTRACT

Methods and systems for processing transactions are disclosed. An example method can comprise generating or manipulating an account. The account can be activated or deactivated based on user controls managed by an account holder of the account. The account can be deactivated or activated by default. The method can comprise receiving instructions for configuring the user controls from the account holder, receiving a request to process a transaction based on the account, and processing the request based on the user controls.

### CROSS REFERENCE TO RELATED PATENT APPLICATION

This application claims priority to U.S. Provisional Application No. 61/869,936 filed Aug. 26, 2013, herein incorporated by reference in its entirety.

### SUMMARY

It is to be understood that both the following general description and the following detailed description are exemplary and explanatory only and are not restrictive, as claimed. Provided are methods and systems for managing accounts and processing transactions. An example method can comprise generating or manipulating an account. The account can be activated or deactivated based on user controls managed by an account holder of the account. The account can be deactivated or deactivated by default. Instructions for configuring the user controls can be received from the account holder. A request to process a transaction based on the account can be received. The request can be processed based on the user controls.

In another aspect, an example method can comprise receiving a request to process a transaction based on an account. The account can be activated or deactivated by user controls managed by an account holder of the account. The account can be deactivated or activated by default. Whether the account is activated or deactivated based on the user controls can be determined. The request can be denied or accepted based on the determination of whether the account is activated or deactivated.

In yet another aspect, an example method can comprise receiving, at a first device, a request to process a transaction based on an account. A second device configured to service the account can be determined. The second device can be configured to authorize or deny transfer of funds from the account based on user controls that activate or deactivate the account based on input from an account holder of the account. The account can be deactivated or activated by default. Authorization, from the second device, can be requested to transfer funds from the account based on the transaction. A response to the request for authorization can be received, from the second device. The response can be based on the user controls. The transaction can be processed based on the response.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating various aspects of an exemplary system for managing accounts and processing transactions;

FIG. 2 is a diagram illustrating management by a user and account manager of an account in accordance with the present methods and systems;

FIG. 3 is a flowchart illustrating example logic for processing a transaction;

FIG. 4 is a diagram illustrating an example workflow for managing an account;

FIG. 5 is a diagram illustrating an example user interface for a mobile device;

FIG. 6 is a diagram illustrating an example user interface accessible as a website;

FIG. 7 is a diagram illustrating another example user interface for managing an account via a website;

FIG. 8 is a flowchart illustrating an example method for processing an account;

FIG. 9 is a flowchart illustrating another method for processing an account;

FIG. 10 is a flowchart illustrating another method for processing an account; and

FIG. 11 is a block diagram illustrating an example computing device in which the present methods and systems can be implemented.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for managing an account and processing transactions on the account. An account holder of the account can control an authorization status (e.g., activated or deactivated) of an account based on user controls. An account servicer can allow or deny transactions based on the status of the account as defined by the user controls. The present methods and systems can be implemented allowing a user to manage user controls through a dedicated application, website, web-service, secure social site, mobile device application (e.g., mobile app), telephone (IVRNRU) interface, and/or any other channel by which the account holder can access account information.

The present methods and systems can be configured to allow the account holder (e.g., authorized user) to control the times during and/or conditions under which one or more payment devices associated with an account are active. Example payment devices can comprise a secure element, payment card, RFID tag, key fob or sticker, mobile phone (e.g., via near-field communication, Wi-Fi, Bluetooth, QR Code, virtual card number), and/or the like. The present methods and systems allow for authorization for payment and/or other transfer of funds used in the exchange of goods and services. As a further example, an account can comprise a credit account, debit account, pre-paid account, and/other stored values such as gifts, reward points, incentive points, and/or discounts that can be used in exchange for goods, services, and/or experiences.

The present methods and systems can be invoked in real-time manually or according to user controls that define rules set up in advance by the account holder based on geo-location, day of week, time of day, type of good/service purchased, type of transaction (e.g., “card not present” transactions, via the internet, via phone), or other such variables as determined by the account holder alone or in conjunction with another. These controls may be invoked on behalf of the user or by the user.

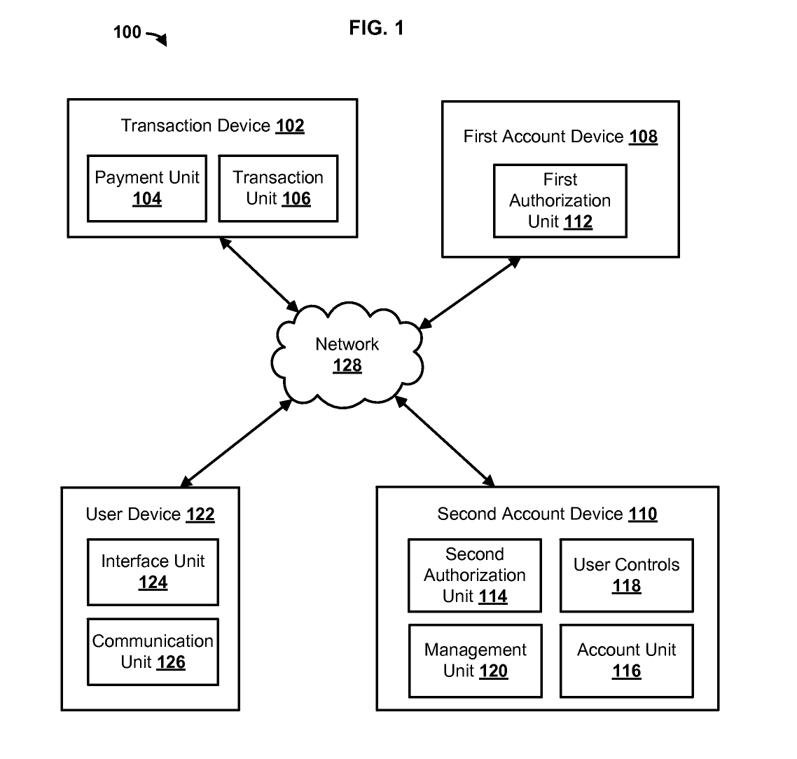

FIG. 1 is a block diagram illustrating various aspects of an exemplary system for managing accounts and processing transactions. Those skilled in the art will appreciate that present methods may be used in systems that employ both digital and analog equipment. One skilled in the art will appreciate that provided herein is a functional description and that the respective functions can be performed by software, hardware, or a combination of software and hardware.

In an aspect, the system 100 can comprise a transaction device 102 configured to process a transaction. For example, the transaction device 102 can comprise a point of sale terminal, such as a cash register, mobile terminal, and/or the like. The transaction device 102 can comprise a payment unit 104 configured to receive payment information, such as an account number, account holder name, user credentials. For example, the payment unit 104 can comprise a card reader, scanner, wireless receiver, and/or the like for receiving account information from credit cards, debit cards, gift cards, mobile devices (e.g., mobile phone), radio frequency identification (RFID) chips, and/or the like.

In one aspect, the transaction device 102 can comprise a transaction unit 106 configured to process a transaction. For example, the transaction unit 106 can be configured to receive a list of one or more items for purchase. The transaction unit 106 can be configured to determine any applicable taxes, discounts, fees, and/or the like associated with purchase of the items for purchase. The transaction unit 106 can be configured to calculate a total price for the transaction. The transaction unit 106 can be configured to provide account information, user credentials, transaction information (e.g., amount of payment, goods or services to exchange, category of transaction), location information (e.g., location of purchase), and/or the like to a remote device with a request for authorization of the transaction. The transaction unit 106 can be configured to provide (e.g., via a display) a result of the request for authorization, thereby indicating whether the transaction is approved or denied. In one aspect, the transaction unit 106 can provide information regarding the account, such an account status (e.g., activated, deactivated), reason for transaction denial, and/or the like.

In one aspect, the system 100 can comprise a first account device 108 and/or a second account device 110. The first account device 108 can be configured to receive the request for authorization from the transaction device 102. The first account device 108 can comprise a first authorization unit 112. The first authorization unit 112 can be configured to determine an account servicer associated with the account. For example, the first authorization unit 112 can determine a financial institution (e.g., bank, creditor) servicing the account and/or any corresponding devices associated with the financial institution. For example, the first authorization unit 112 can determine that the account is serviced by the second account device 110. The first authorization unit 112 can request information from the second account device 110. The information can comprise account information, such as balance information, activation status, and/or the like. The first authorization unit 112 can be configured to provide a request to the second account device 110, such as a request to transfer funds, request for authorization to transfer funds, and/or the like. Upon receiving the information and/or a response to the request, the first authorization unit 112 can be configured to process the transaction. For example, the first authorization unit 112 can deny the transaction (e.g., if the account is deactivated and/or the transaction is otherwise unauthorized). The first authorization unit 112 can approve the transaction (e.g., if the account is activated and/or the transaction is otherwise authorized). The first authorization unit 112 can provide a response authorizing or denying the transaction to a remote device, such as the transaction device 102. The response can comprise information, such as reason for approval or deny, account balance, notifications, coupons, reward points, and/or the like.

In one aspect, the second account device 110 can comprise a second authorization unit 114. The second authorization unit 114 can be configured to receive and process requests from other devices, such as the first account device 108 and the transaction device 102. For example, the second authorization unit 114 can be configured to receive and process requests for information, requests to transfer funds, request for authorization to process a transaction, and/or the like. In one aspect, the second account device 110 can comprise an account unit 116. The account unit 116 can comprise information associated with one or more customer accounts. An account can be, for example, a bank account, credit card account, debit card account, gift card account, line of credit, rewards account, and/or the like. For example, one or more of the accounts can be associated with corresponding financial information, such as a monetary balance, transaction history, account holders, account number, and/or the like.

In one aspect, the second account device 110 can comprise user controls 118. For example, the user controls 118 can comprise rules associated with a user account. The rules can be default rules, rules configured by an account manager, rules configured by the account holder, and/or the like. Rules can comprise unique combinations of conditions and criteria that result in user specific authorization controls.

In an aspect, conditions can comprise space-time conditions, category conditions, mathematical conditions, and/or the like. The conditions can be evaluated for compliance with the rules. Space-time conditions can comprise relativistic space-time coordinates in a standard frame of reference. Category conditions can comprise classification schemes for inclusion or exclusion, such as merchant control codes (MCCs), standard industry codes (SIC) or other classification schemes to be determined. Mathematical conditions can comprise logical or algebraic expressions that can be evaluated to provide for such limiting factors such as upper or lower limits, ranges, and specific counters as defined by criteria below.

In an aspect, criteria can comprise boolean logic gates used to modify conditions to create unique rules for the above conditions. Space-time criteria can comprise “always” provisions (e.g., if condition X is met, always do Y), locations and geospatial-temporal ranges and schedules. Category criteria comprise historical criteria (e.g., previously known charge or vender, payment with historic range of payments), categories, mathematical criteria, and/or the like. Mathematical criteria can be used to screen for minimums, maximums, ranges, counters, and/or the like. Mathematical criteria can be set to require exact amounts, specific amount sets, multiple ranges, and/or the like.

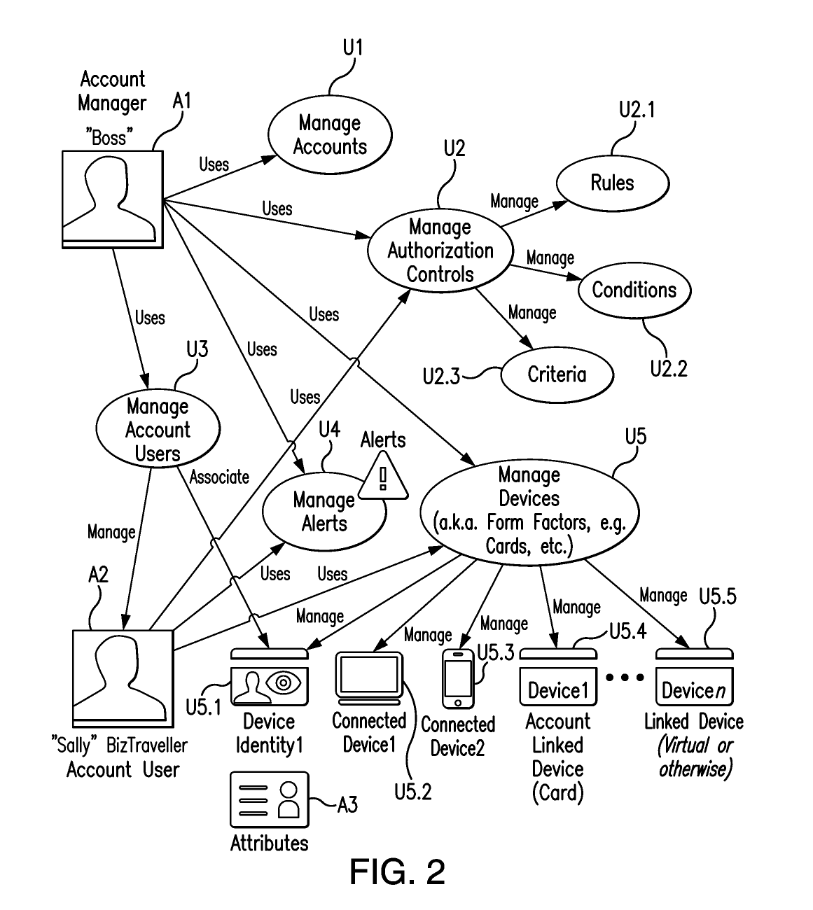

By way of illustration, the following are example user controls. An account can have a first “OFF” status. In an aspect, the first OFF status can be similar to a pause of an account. The first OFF status can configure all devices (e.g., FIG. 2, U5.1-U5.5) associated with the account to be deactivated, thereby allowing no transactions. For example, credit and/or debit cards or other payment methods associated with an account can be declined. As another example, pre-existing advanced directives such as automated clearinghouse (ACH) drafts and electronic funds transfer (EFT) requests of either a debit or credit nature can be prevented if the account is configured with the first OFF status. As a further example, an account with the first OFF status can prevent funds from being added or subtracted from the account except for chargebacks, normal account management, monthly charges, interest accruals, processing fees, and/or the like per the account holder agreement.

An account can have a second OFF status. The second OFF status can allow for deposit only. This status is similar to the first OFF status, except that credits may be added to the account. The second OFF status can be the default deactivation status and/or the status of an account when it is generated and provided to the account holder.

An account can have a third OFF status. In the third OFF status, the account is activated for credits and debits (e.g., or other transfer of funds) for previously authorized amounts, transactions, and/or the like. For example, credits can be allowed as well as debits (e.g., or other transfer of funds) for previously authorized amounts within a certain tolerance factor, such as 1%, 5%, 10%, 15%, of the previously authorized amount. For example, the third OFF status can allow for mortgages, consumer loans, insurance, utilities, and/or the like to auto draft and vary slightly from period to period by a certain amount. A user defined tolerance can set limit ranges for auto-authorization. Transactions declined in this mode can trigger authorization control alerts (e.g., FIG. 2, U4).

An account can have a fourth OFF status. The fourth OFF status can configure an account to be OFF until a condition X and/or other criteria are met. The condition X can be a date, time, user interaction, or other criteria disclosed herein.

An account can have a first ON status. The first ON status can configure an account to be activated, thereby receiving user authorization for all transactions. An account can have a second ON status. The second ON status can configure an account to allow for only transactions that transfer funds out of the account. The second ON status can be a special purpose disburse only mode used to deplete funds from an account and not accept additional funds except per the account holder agreement. An account can have a third ON status. The third ON status can configure an account to be ON (e.g., activated) until a condition X is met. For example, the third ON status can configure an account to be activated for or until X uses. After the condition is met, the account can proceed to another status, such as a deposit only (e.g., second OFF) status.

As a further illustration, user controls can be defined as follows:

“Off [for normal]”: Off based on user defined “normal” where the default normal condition is “for now” (e.g., “Off for now” until user turns account ON).

“Off [unless pre-authorized]”: Off for transactions except pre-authorized recurring transactions, such as Card Not Present (CNP) and/or Electronic Funds Transfer (EFT) charges.

“Off [for categories]”: Off for categories specified by user.

“Off [for geolocation]”: Off for locations meeting user criteria.

“On [for normal]”— On based on user defined “normal” where the default normal condition is “for now” (e.g., “On for now” until user turns account Off).

“On [for a time]”— On for a user specific range or schedule.

“On [for a (single) transaction]”: One time use, then OFF.

“On [for categories]”: On for specific categories of transactions.

“On [for geolocation]”: On for locations meeting user geolocation criteria.

In an aspect, the second account device 110 can comprise a management unit 120.

The management unit 120 can be configured to provide account holders, account managers, and/or the like services for updating account information, user controls, and/or the like. For example, the management unit 120 can provide an interface (e.g., or data to be processed by a browser to implement an interface) configured to allow account holders to modify the user controls, account information, and/or the like. The interface can be provided by a web server, mobile app server, telephone call menu service, and/or the like.

In one aspect, the management unit 120 can also be configured to provide notifications to account holders. Example notifications can comprise a notification that an account has been activated and/or deactivated, warning notifications that a transaction request has been rejected, account balance notifications, and/or the like. As an illustration, if a transaction is rejected based on the user controls, the management unit 120 can provide a notification to the account holder that the transaction has been rejected. The notification can indicate one or more reasons for the rejection. The notification can be provided via an email, a mobile application, a text message, and/or the like.

As another example, the notification can be provided to a virtual device interface (VDI) with a companion utility indicator to convey account status. This VDI may be integrated with simple sensors and output devices like a light emitting diode (LED) indicator or complex physical hardware and machinery with a heads-up display (HUD), liquid crystal display (LCD), LED, cathode ray tube (CRT) or other similar visual output device, such as found on a computer, television or phone. Using the VDI, it may also send and respond to signals logically, and be used to “wire” up to application icons, active tiles, really simple syndicate (RSS) feeds, audible, visual or haptic or tactile stimulus, alerts and notifications and responses such as produced from vibrating components, electromagnetic pulse (EMP) emitters or interruptible gyros.

It should be noted that the features of the second account device 110 can be implemented in one device or multiple devices. The one or more devices can perform some or all of the features and services of the second account device 100 in coordination, separately, and/or the like. For example, the management unit 120 and/or other unit can be implemented through one or more servers connected through a variety of communication channels.

In one aspect, the system 100 can comprise a user device 122. The user device 122 can be configured to provide content, services, information, applications, and/or the like to one or more users. For example, the user device 122 can comprise a computer, a smart device (e.g., smart phone, smart watch, smart glasses, smart apparel, smart accessory), a laptop, a tablet, a set top box, a display device (e.g., television, monitor), digital streaming device, proxy, gateway, transportation device (e.g., on board computer, navigation system, vehicle media center), sensor node, and/or the like.

In one aspect, the user device 122 can comprise an interface unit 124 configured to provide an interface to a user to interact with the user device 122 and/or remote devices, such as the transaction device 102, first account device 108, second account device 110, and/or the like. The interface unit 124 can be any interface for presenting and/or receiving information to/from the user, such as user feedback. An example interface can comprise a content viewer, such as a web browser (e.g., Internet Explorer®, Mozilla Firefox®, Google Chrome®, Safari®, or the like), media player, application (e.g., web application, mobile application), and/or the like. Other software, hardware, and/or interfaces can be used to provide communication between the user and one or more of the user device 122 and the transaction device 102, first account device 108, second account device 110, and/or the like.

In one aspect, the user can be a customer of a financial institution, such as an account holder. In another aspect, the user can be an account manager, such as a manager associated with the financial institution, an administrator of a business for which the account holder works, and/or the like. For example, the interface can comprise an interface configured to allow the user to activate and/or deactivate an account. The interface can be configured to allow users to configure user controls as described herein. For example, the interface can provide an interface element, such as a button, configured to allow a user to activate (e.g., turn on) and/or deactivate (e.g., turn off) the account. The interface can also provide other interface elements, such as input boxes, drop down boxes, radio buttons, check boxes, and/or the like configured to allow user to configure user controls specifying conditions for activation and/or deactivation of an account.

In an aspect, the user device 122 can comprise a communication unit 126. As an example, the communication unit 126 can request or query various files from a local source and/or a remote source. As a further example, the communication unit 126 can transmit and/or receive data to a local or remote device such as the transaction device 102, first account device 108, second account device 110, and/or the like. The communication unit 126 can comprise hardware and/or software to facilitate communication. For example, the communication unit 126 can comprise one or more of a modem, transceiver (e.g., wireless transceiver)), digital-to-analog converter, analog-to-digital converter, modulator, demodulator, and/or the like. In one aspect, the communication unit 126 can be configured to allow one or more remote devices (e.g., in a local or remote portion of the network 128) to control operation of the user device 122.

In one aspect, system 100 can comprise a network 128. The network 128 can comprise a packet switched network (e.g., internet protocol based network), a non-packet switched network (e.g., quadrature amplitude modulation based network), and/or the like. The network 128 can comprise network adapters, switches, routers, modems, and the like connected through wireless links (e.g., radio frequency, satellite) and/or physical links (e.g., fiber optic cable, coaxial cable, Ethernet cable, or a combination thereof). The network 128 can comprise public networks, private networks, wide area networks (e.g., Internet), local area networks, and/or the like. The network 128 can comprise a content access network, content distribution network, and/or the like. In one aspect, the network 128 can be configured to provide communication from telephone, cellular, modem, and/or other electronic devices to and throughout the system 100. For example, the network 128 can be configured to communicatively couple one or more of the transaction device 102, first account device 108, second account device 110, user device 122, and/or the like.

FIG. 2 is a diagram illustrating management by a user and account manager of an account in accordance with the present methods and systems. In one aspect, the exemplary system can comprise a variety of actors, such as a payee (e.g., merchant), account manager, account user (e.g., account holder), and/or the like. The payee can comprise a location and/or provider with which an account user is attempting to authorize a transaction. An example account manager is shown at A1. The account manager can view, access, create, update, delete, and/or perform similar management of accounts. The account manager can manage accounts, account users, authorization controls (e.g., user controls), alerts, devices, and/or the like. An example user (e.g., account holder) is shown at A2. An account holder can be an authorized user of a given account. As shown at A3, account attributes can be managed. Various account attributes can be stored in the platform or system of record.

In one aspect, the exemplary system can be used in a variety of scenarios as follows. At use case U1, accounts can be managed. For example, accounts can be created, updated, deleted, and/or the like. At use case U2, authorization controls can be managed. For example, authorization controls (e.g., user controls) can be created, updated, deleted, and otherwise managed. At use case U2.1, rules can be managed. Rules can comprise combinations of conditions and criteria that result in user specific authorization controls (e.g., user controls).

At use case U2.2, conditions can be managed. A variety of different types of conditions (e.g., space-time, category, mathematical) can be evaluated for compliance with the rules in use case U2.1. Space-time conditions can comprise relativistic space-time coordinates in a standard frame of reference. Category conditions can comprise classification schemes for inclusion and/or exclusion, such as merchant control codes (MCCs), standard industry codes (SIC), and/or other present and future classification schemes. Mathematical conditions can comprise logical or algebraic expressions that can be evaluated to provide for such limiting factors such as upper or lower limits, ranges, specific counters as defined by criteria (e.g., see use case U2.3) below, and/or the like.

At use case U2.3, criteria can be managed. For example, Boolean logic gates can be used to modify conditions to create unique rules for the conditions (e.g., see use case U2.2). Space-time criteria can comprise “always” provisions, locations, geospatial-temporal ranges, schedules, and/or the like. Category criteria can comprise a previously known charge and/or vendor, within a historical range of payments from a vendor, and/or the like. Mathematical criteria can comprise minimums, maximums, ranges, counters, and/or the like. Mathematical criteria can be set to require exact amounts, specific amount sets, multiple ranges, and/or the like.

At use case U3, account users can be managed. For example, account managers can manage account users. Such configuration allows for greater democratization of financial control. At use case U4, alerts can be managed. Account managers and/or users (e.g., account holders) can manage (e.g., create, update, delete) authorization control specific alerts. At use case U5, devices can be managed. For example, as part of account information for a particular account, devices can be created, updated, deleted, and/or associated with an account and/or account user. Example devices can comprise magnetically encoded-striped cards, embedded smart cards with an on-board chip, mobile connected devices (e.g., smart phones), game systems, personal computers (PC), tablet computer, paper-based loyalty, quick-response (QR) or bar codes, radio frequency identification (RFID) tags, secure elements (SEs), near-field communication (NFC) stickers, and/or the like. Though only a few devices are shown in FIG. 2, it should be understand that the present methods and systems are not limited to such devices.

At use case U5.1, device identity(s) can be managed. For example, a device identity can comprise an identity credential, like a government issued ID, or user credential. At use case U5.2, a first connected device, such as a computer, can be managed. At use case U5.3, a second connected device, such as a mobile phone can be managed. At use case U5.4, a first account-linked device, such as a magnetically encoded card can be managed. At use case U5.5, additional account-linked devices (e.g., virtual or otherwise) can be managed.

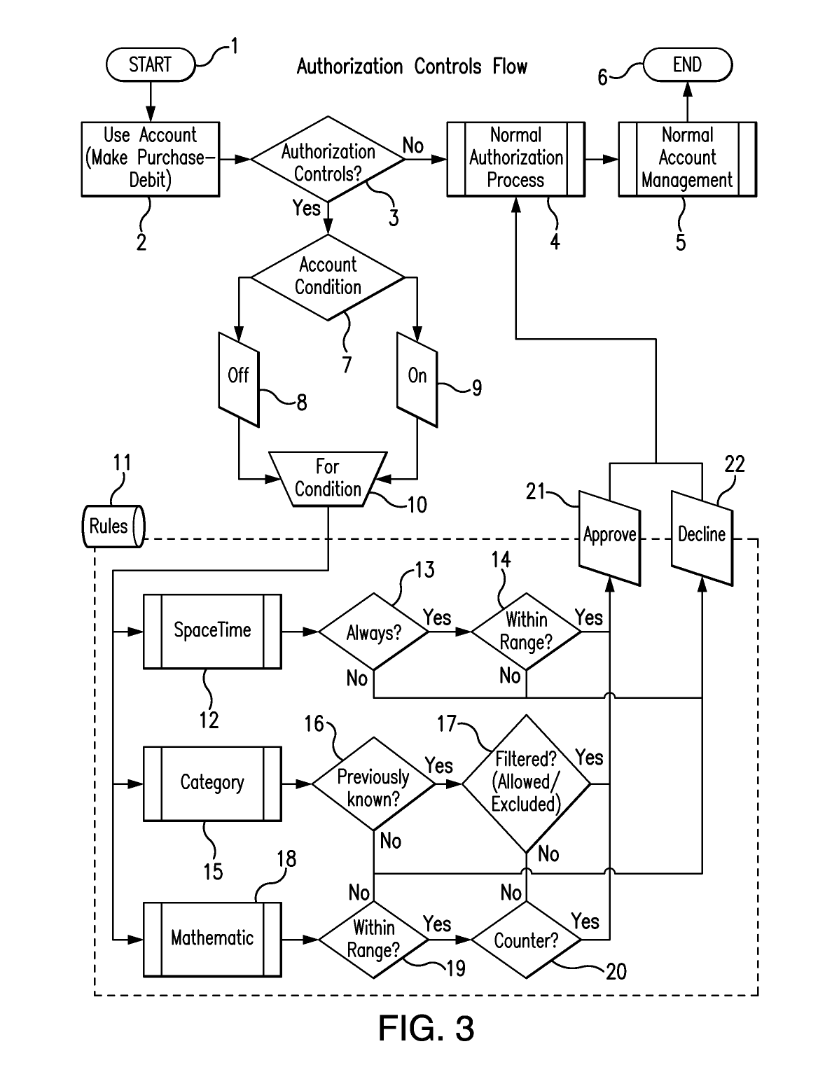

FIG. 3 is a flowchart illustrating example logic for processing a transaction. At step 1, an example process for evaluating a transaction can begin. At step 2, an account can be used for the transaction. The user can attempt to make a purchase or debit (e.g., subtract from) the account. For example, the user can swipe her credit card at a device (e.g., transaction device 102 of FIG. 1), such as a point of sale (POS) terminal.

At step 3, it can be determined whether the account is associated with authorization controls. For example, it can be determined if the account is associated with a financial institution, account servicer, and/or the like that allows user controls. If the account is associated with authorization controls (e.g., user controls), a device, such as a POS terminal, can route the request to a device configured to evaluate whether or not the authorization controls are in effect (e.g., whether the account is activated or deactivated based on the authorization controls).

At step 4, an authorization process can be performed (e.g., without authorization controls). In the “No” case from step 3, the usual authorization process is executed. Funds availability can be determined, anti-fraud, anti-terrorism and anti-money laundering checks can be conducted as per normal standard operating procedures (SOP).

At step 5, account management can be performed. For example, the user's account can be debited and/or credited the appropriate amount, fees can be assessed, and/or the like. An accounting can be posted, cleared, and settled. If the authorization was affirmative (e.g., authorized), then the user can be charged and the merchant paid. If declined, then alerts (if any) are processed for the user and the merchant is so advised. At step 6, the process can be completed. Accounts can be updated and if applicable, monies can be appropriately exchanged.

At step 7, it can be determined if an account is associated with account conditions, such as authorization controls. If authorization controls (e.g., at step 3) are enabled “Yes” for the account, the transaction can begin to execute the authorization controls process. At step 8, the transaction can be subsequently evaluated for conditional “Off” Path. At step 9, the transaction can be evaluated for a conditional “On” Path. In an aspect, step 8 and step 9 can be executed in parallel.

At step 10, a “For Condition” Switch can be set to the current transaction context and evaluated according to whatever rules exist in the rules container. As illustrated by box 11, the transaction can be evaluated based on data stored in a rules container. The rules container can comprise an electronic storage mechanism (e.g., database, linked-list) that maintains an enumerated matrix, list, and/or the like of conditions and criteria to be used to evaluate the authorization controls for a given transaction.

At step 12, space-time rules can be selected for evaluation. The current transaction context “For Condition” (e.g., from step 10) can be tested against any and all space-time rules for compliance. As shown in step 13 and 14, evaluation of space—time rules can comprise determining whether an “Always,” criteria, “Within Range,” and/or the like criteria are met. These are representative (but not exclusive or limiting) examples of these criteria.

At step 15, category rules can be selected for evaluation. The current transaction context “For Condition” (e.g., from step 10) can tested against any and all category rules for compliance. As shown in step 16 and 17, “Previously Known,” “Filtered (e.g., allowed or excluded),” and/or the like criteria can be evaluated. These criteria are representative (but not exclusive or limiting) examples of allowances or exclusion criteria.

At step 18, mathematical rules can be selected for evaluation. The current transaction context “For Condition” (from step 10) can be tested against any and all category rules for compliance. As shown in step 19 and 20 “Within Range,” “Counter,” and/or the like criteria can be evaluation. The criteria are representative (but not exclusive or limiting) examples of mathematical criteria.

At step 21, if the transaction is approved, the process can proceed to the approve path. The aggregate logical AND result of all previous evaluations that evaluates to a “yes” answer can result in an authorization controlled transaction being conditionally approved. The logical AND process requires unanimous yes evaluations to result in an approval. A single “no” anywhere in the path will result in a decline.

At step 22, if the transaction is declined, the process can proceed to the decline path. The aggregate logical AND result of all previous evaluations that evaluates to a “no” answer will result in an Authorization Controlled transaction being unconditionally denied, and will result in a declined transaction authorization. Any no results in a decline.

For example, a card holder can be declined because the card holder has the card or cards set to off (e.g., deactivated). If this is the case and the card holder attempts to make a purchase, the card processing system of the servicer can recognize that the card holder has the card holder's card(s) locked (e.g., deactivated), set to off, suspended and/or the like. The servicer can generate an alert notifying the card holder to this situation. The alert can be provided to a mobile device via SMS, text, email, or similar notification format. The card holder can then enable the card holder's card(s) via the card holder's mobile device (e.g., or other device) using user credentials, such as a password, PIN, and/or the like.

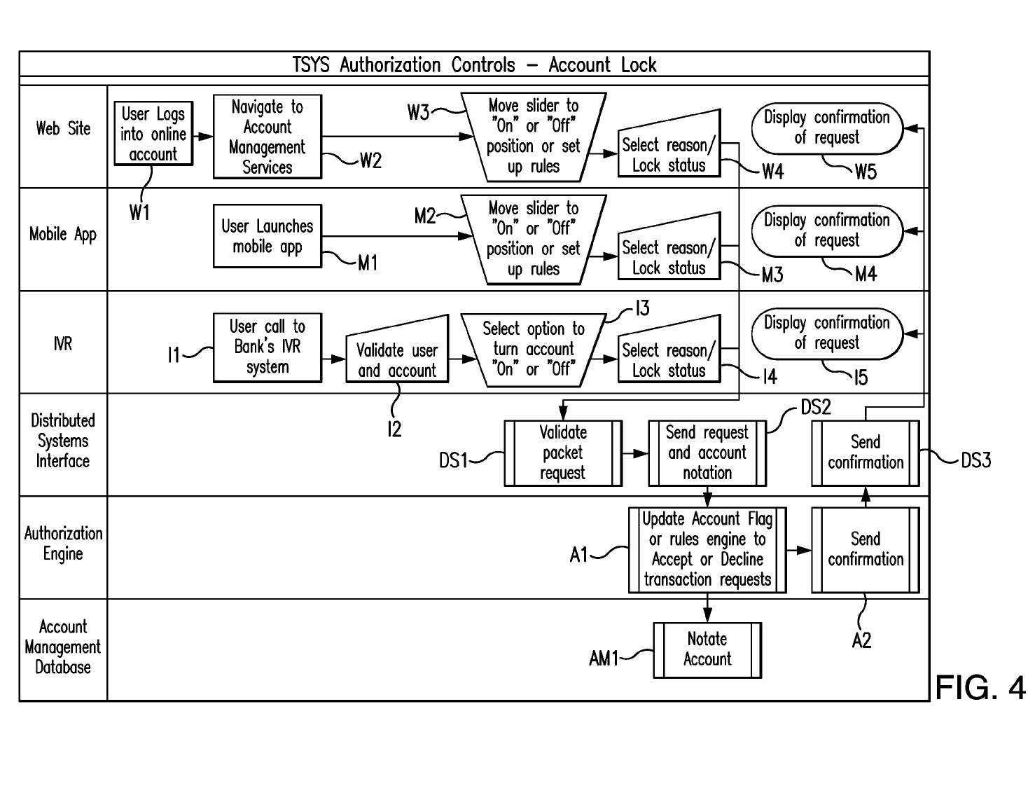

FIG. 4 is a diagram illustrating an example workflow for managing an account. For example, workflows are illustrated for a user to manage user controls via a website, mobile application, interactive voice response (IVR). Workflows are illustrated for a service to allow users to manage controls via a distributed system interface, authorization engine, and account management database. The website workflow is illustrated as steps W1, W2, W3, W4, and W5. For example, at step W1, a user can log into an online account. At step W2, the user can navigate to Account Management Services. At step W3, the user can move a slider to “On” or “Off” position and/or set up rules. At step W4, the user can select an account status (e.g., deactivation status) and/or a reason for the account status. At step W5, a confirmation that the request (e.g., to turn account On or Off or to set authorization rules) has been processed can be displayed to the user.

The mobile application workflow is illustrated as steps M1, M2, M3, and M4. For example, at step M1, a user can launch a mobile app. At step M2, the user can move a slider to “On” or “Off” position and/or set up rules. At step M3, the user can select an account status and/or a reason for the account status. At step M4, a confirmation that the request (e.g., to turn account On or Off or to set authorization rules) has been processed can be displayed to the user.

The IVR workflow is illustrated by steps I1, I2, I2, I4, and I5. For example, at step I1, a user can place a call to a servicer's (e.g., bank) IVR system. At step 12, the user can validate user and account information. At step I3, the user can select option to turn account “On” or “Off”. At step I4, the user can select an account status and/or reason for account status. At step I5, a confirmation that the request (e.g., to turn account On or Off or to set authorization rules) has been processed can be displayed to the user.

The distributed system interface workflow is illustrated by steps DS1, DS2, DS3. For example, at step DS1, a packet request can be validated. At step DS2, a request (e.g., to change user controls) an account notation can be sent (e.g., to authorization engine). At step DS3, confirmation can be received (e.g., from authorization engine) and sent to the user.

The authorization engine workflow is illustrated by steps A1 and A2. At step A1, an account flag and/or rules engine can be updated (e.g., based on user input) to accept or decline transaction requests. At step A2, confirmation can be sent (e.g., to the distribute systems interface indicating that the request has been processed). The account management database workflow is illustrated by step AM1. At step AM1, the account can be notated (e.g., at the account management database).

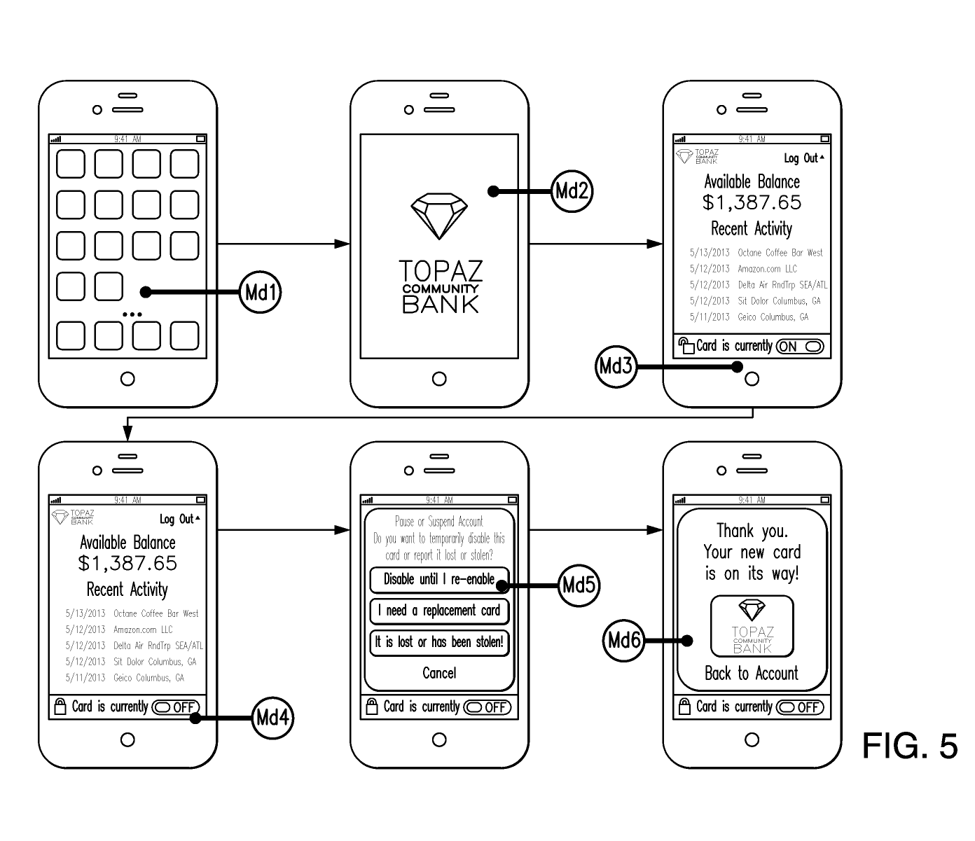

FIG. 5 is a diagram illustrating an example user interface for a mobile device. A stand-alone application or application programming interface (API) integrated into a servicer's mobile application can be used to manage user controls associated with an account. As shown at Mdl, the user (e.g., account holder) can launch the mobile application. The mobile application can authenticate the user based on existing methods (e.g., step M1 of FIG. 4). Once the user has access to the application, a graphical representation of the user controls can be provided on the user's screen as shown at Md3 (e.g., step W2 of FIG. 4). Using the interface, the user can move a slider (e.g., check box, radio button, or other input method) to indicate whether the user chooses to allow or deny all authorization requests (e.g., activating or deactivating the account). As shown at Md4, by choosing to turn the user control to the “Off” position any attempts to make a purchase using the account holder's account will automatically be denied. As shown at Md5, the account holder can also select a reason for their choice to turn off (e.g., deactivate) and/or turn on (e.g. activate) the account, such as a temporary state or to indicate that a card associated with the account has been lost or stolen (e.g., step M3 of FIG. 4). If the card is lost or stolen, the servicer of the card can initiate a process for ordering and mailing a new card.

Once the user has selected and/or input the account status, the application can (e.g., by use of an API) send a message to the service (e.g., via a distributed system interface). Once the package has been received it will be validated through existing rules (e.g., step DS1 of FIG. 4). After validation, a command message can be sent to the authorization engine (e.g., step DS2 of FIG. 4) where the designated account profile flag will be updated with the selected state (e.g., step A1 of FIG. 4). Once complete, a message can be sent back to the distributed systems interface (e.g., step A2 of FIG. 4) and then, to the mobile device (e.g., step DS3 of FIG. 4) where the user will then see a confirmation of the action, as shown at Md6. A message can also be sent to the account management database (e.g., step AM1 of FIG. 4) where a note can be placed on the account documenting the date and time, user requesting the change, the request type (e.g., “On” or “Off”), method of change, selected reason, and/or the like information. It should be noted that, though not shown in FIG. 5, the present methods and systems also contemplate assigning user controls that determine activation and/or deactivation status based on day, time, geo-location, categories, and/or the like.

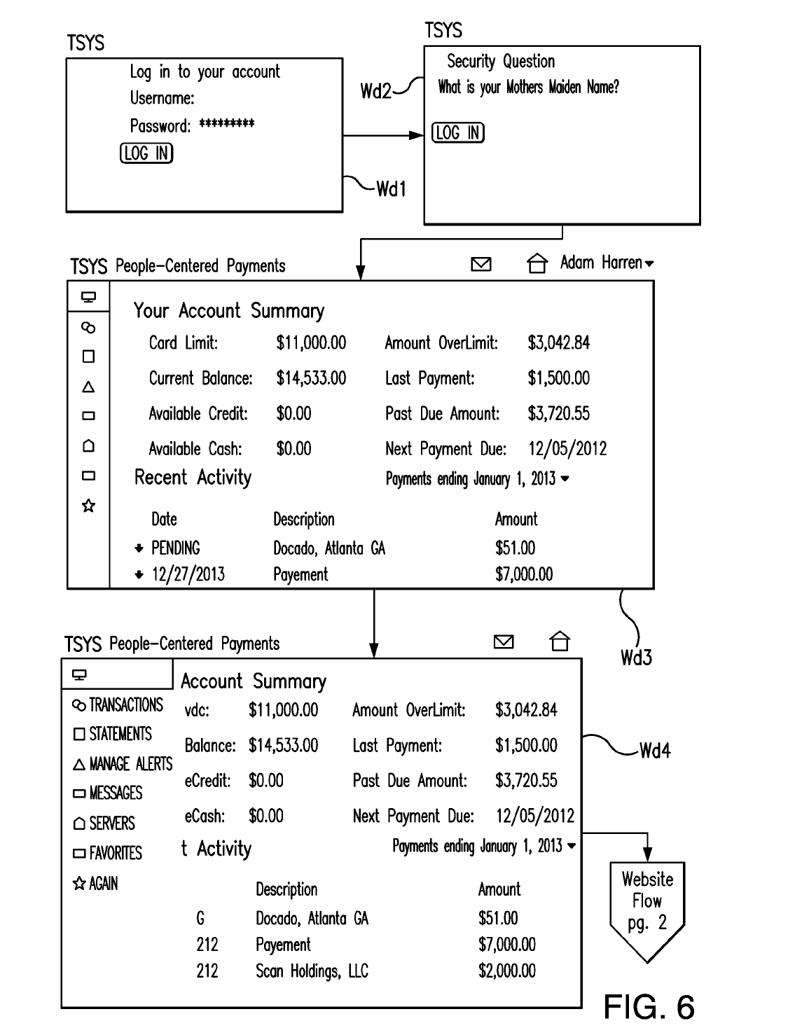

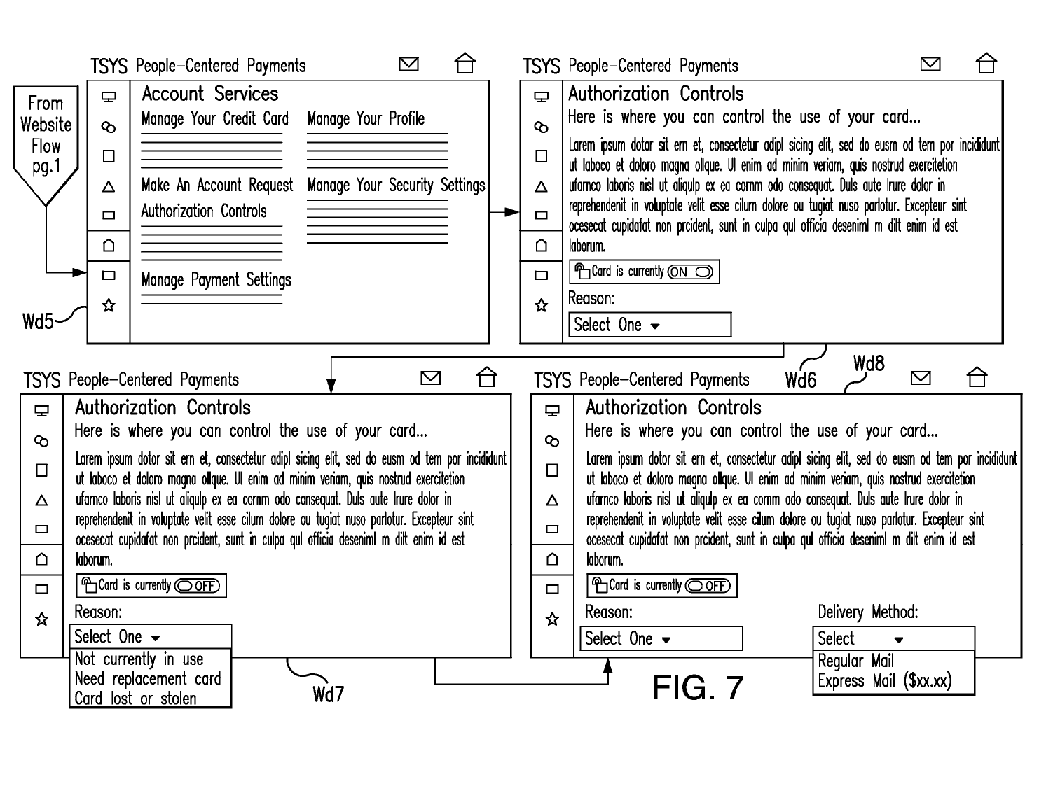

FIG. 6 and FIG. 7 are diagrams illustrating an example user interface accessible as a website. At window Wd1, a login screen is shown for a user (e.g., account holder to login to an account). At window Wd2, a security screen is shown requesting additional information from the user to login. At window Wd3, account information is shown, such as account summary (e.g., monetary balance) and recent account activity (e.g., recent purchases). At window Wd4, an additional account summary page is shown. At window Wd5, an account services page is shown. At window Wd6, an authorization controls page is shown. At window Wd7, an additional authorization page is shown illustrating an input box for providing a reason associated with a user control. At window Wd8, an additional authorization page is shown illustrating a delivery method.

The user can access account information via the account servicer's (e.g., account issuer) website (e.g., step W1, windows Wd1, Wd2). The user can then navigate to the account management services page(s) of the site (e.g., step W2, windows Wd3, Wd4, Wd5). The user can navigate to the Authorization Controls (e.g., window Wd6) page. On the Authorization controls page, the user can be presented a graphical representation of the user controls (e.g., windows Wd6, Wd7, Wd8).

The user can move a slider, check box, radio button, or other input method, to indicate whether the user chooses to allow or deny all authorization requests and choose the reason for the change. The process can proceed in a similar manner as illustrated for the mobile interface of FIG. 5. It should be noted that other user interfaces can be utilized by a user to manage an account. For example, a similar workflow to the ones outlined above can used for users interacting through a telephony device or other channel by which an account holder may access an account.

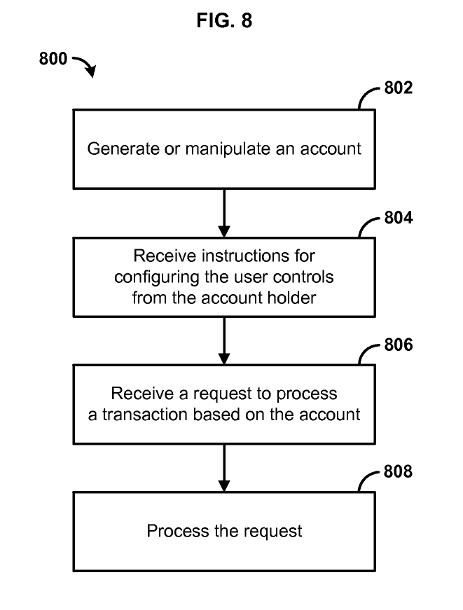

FIG. 8 is a flowchart illustrating an example method 800 for processing an account. At step 802, an account can be generated and/or manipulated (e.g., accessed, updated, edited). The account can be activated or deactivated based on user controls managed by an account holder of the account. In an aspect, the account can be deactivated or activated by default. For example, when the account is generated and/or manipulated, the user controls can be set (e.g., by the account servicer) to deactivate the account until activated by user input configuring one or more controls of the user controls.

The user controls can control activation of the account. The user controls can be based on at least one of a time limitation, a geospatial limitation, a mathematical limitation, and/or the like. For example, the user controls can comprise a control configured to switch between activation and deactivation of the account. For example, activation can allow disbursement of funds from the account. Deactivation can prevent disbursement of funds from the account. For example, the account can be deactivated or activated based on at least one of an account flag associated with the user controls and evaluation of an authorization rule associated with the user controls. For example, the servicer of the account can associate an account flag with the account indicating the account is deactivated. The account flag can be stored as a boolean value, status value, and/or the like. As another example, the account can be deemed deactivated (e.g., for a particular transaction) if the transaction does not properly satisfy the authorization rule specified by the user controls.

In an aspect, an interface comprising inputs for configuring the user controls can be provided. For example, the interface can be provided to the account holder (e.g., authorized representative of the account holder). The interface can be provided as a website, mobile application, telephone, and/or the like.

At step 804, instructions for configuring the user controls can be received. For example, the instructions can be received from the account holder (e.g., authorized representative of the account holder). For example, the instructions can be received based on an interaction with a button, switch, textbox, slider and/or or the like. The instructions can be received from a text message, email, telephone input, and/or the like. For example, the instructions can comprise geospatial limitations (e.g., time limitations, location limitations, proximity limitations), category limitations (e.g., type of product limits, type of payee or vendor limits), mathematical limitations (e.g., cost range, cost limits).

At step 806, a request to process a transaction based on the account can be received. For example, the request can be received from a vendor, point of sale terminal, payment service device, and/or the like. The account holder (e.g., authorized representative) can attempt to purchase a product and/or service from a store, business, online store, service provider, and/or the like.

At step 800, the request can be processed based on the user controls. In some scenarios, the request can be processed without the user controls. Processing the request can comprise determining whether the request is authorized. For example, it can be determined whether the request is authorized based on the user controls. The request can be authorized based on whether the account is activated and/or deactivated based on the user controls. If the request is authorized, then the request can be approved and the transaction can be performed, such as transfer of funds. As another example, processing the request can comprise denying the request based on the user controls. If the account is deactivated (e.g., turned off, evaluated as deactivated based on the user controls), then the request can be denied and the transaction can be terminated.

In an aspect, a notification can be provided to the account holder. The notification can be related to the denying of the request, acceptance of the request, and/or the like. The notification can be provided via a SMS message, email, paper mail, application notification, activation of an indicator (e.g., on a notification device, such as a key fob), and/or the like.

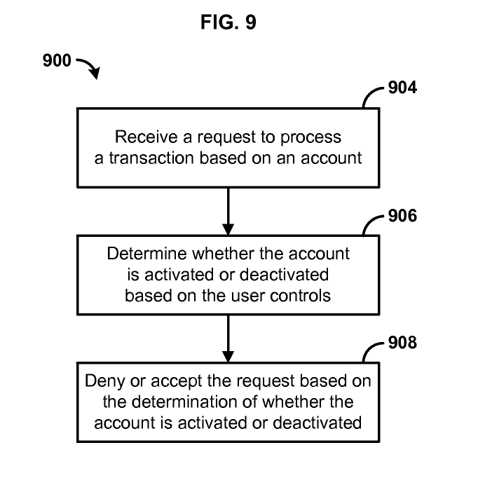

FIG. 9 is a flowchart illustrating another method 900 for processing an account. In an aspect, an interface comprising inputs for configuring the user controls can be provided. For example, the inputs can comprise interface elements, such as a button, switch, textbox, slider and/or or the like. The user controls can also be configured via text message, email, telephone input, and/or the like. The interface can be provided as a website, mobile application, telephone, and/or the like. For example, the interface can be provided to the account holder (e.g., authorized representative). The user controls can control activation of the account based on at least one of a time limitation (e.g., time range), a geospatial limitation (e.g., location limitations, proximity limitations), category limitations (e.g., type of product limits, type of payee or vendor limits), and mathematical limitations (e.g., cost range, cost limits). The user controls can comprise a control configured to switch between activation and deactivation of the account. In an aspect, activation can allow disbursement of funds from the account. Deactivation can prevent disbursement of funds from the account. The account can be deactivated or activated based on at least one of an account flag associated with the user controls and evaluation of an authorization rule associated with the user controls. For example, the servicer of the account can associate an account flag with the account indicating the account is deactivated. The account flag can be stored as a boolean value, status value, and/or the like. As another example, the account can be deemed deactivated (e.g., for a particular transaction) if the transaction does not properly satisfy the authorization rule specified by the user controls.

At step 902, a request to process a transaction based on an account can be received. The account can be activated or deactivated by user controls managed by an account holder of the account. The account can be deactivated or activated by default. For example, when the account is generated, the user controls can be set (e.g., by the account servicer) to deactivate the account until activated by user input configuring one or more controls of the user controls.

At step 904, a determination can be made as to whether the account is activated or deactivated based on the user controls. For example, the user controls can be accessed from a local and/or remote data store (e.g., database). For example, information associated with the request can be evaluated based on the user controls. Information associated with the request can comprise location information (e.g., store, geographic coordinate, geographic area), timing information (e.g., time of request), payment information (e.g., amount of funds transfer, account number, account holder credential), and/or the like.

At step 906, the request can be denied or accepted based on the determination of whether the account is activated or deactivated. If the account is activated the request can be accepted. If the account is deactivated (e.g., turned off, evaluated as deactivated based on the user controls), the request can be denied.

In an aspect, a notification related to the denying or accepting of the request can be provided. For example, the notification can be provided to the account holder (e.g., authorized representative). The notification can be provided via a SMS message, email, paper mail, application notification, activation of an indicator (e.g., on a notification device, such as a key fob), and/or the like.

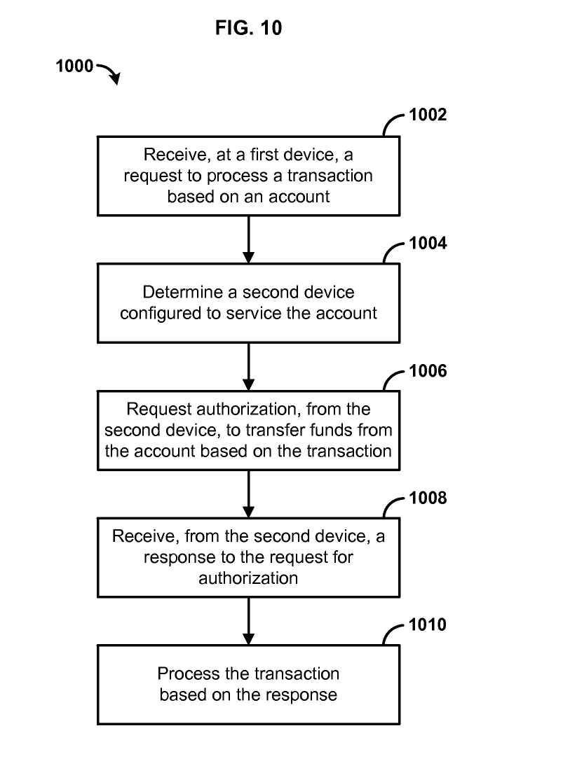

FIG. 10 is a flowchart illustrating another method 1000 for processing an account. At step 1002, a request to process a transaction based on an account can be received at a first device. For example, the first device can comprise a point of sale terminal, register, transaction server and/or other device used to process transactions. The transaction can be a sale of a service, product, and/or the like. For example, the transaction can occur at a retail store, business location, online store, and/or the like.

At step 1004, a second device configured to service the account can be determined. The second device can be determined based on an account number associated with the account. For example, the first device can comprise a list, database, and/or other data structure associating account numbers (e.g., or portions thereof) with one or more corresponding account servicer (e.g., and contact information for communicating with devices managed by the servicer).

The second device can be configured to authorize or deny transfer of funds from the account based on user controls that activate or deactivate the account based on input from an account holder of the account. The account can be deactivated or deactivated by default. For example, when the account is generated, the user controls can be set (e.g., by the account servicer) to deactivate the account until activated by user input configuring one or more controls of the user controls.

The user controls can comprise a control configured to switch between activation and deactivation of the account. For example, the user controls can be configured by the account holder based on a button, switch, textbox, slider and/or or the like. The user controls can be configured based on a text (SMS) message, email, telephone input, and/or the like. The user controls can be accessible by the account holder via an interface comprising inputs for configuring the user controls.

The user controls can control activation (e.g., and deactivation) of the account based on at least one of a time limitation (e.g., time range), a geospatial limitation (e.g., location limitations, proximity limitations), category limitation (e.g., type of product limits, type of payee or vendor limits), a mathematical limitations (e.g., cost range, cost limits), and/or the like.

In an aspect, activation can allow disbursement of funds from the account. Deactivation can prevent disbursement of funds from the account. For example, the account can be deactivated or activated based on at least one of an account flag associated with the user controls and evaluation of an authorization rule associated with the user controls. For example, the servicer of the account can associate an account flag with the account indicating the account is deactivated. The account flag can be stored as a boolean value, status value, and/or the like. As another example, the account can be deemed deactivated (e.g., for a particular transaction) if the transaction does not properly satisfy the authorization rule specified by the user controls.

At step 1006, authorization, from the second device, can be requested (e.g., by the first device) to transfer funds from the account based on the transaction. At step 1008, a response to the request for authorization can be received from the second device. The response can be based on the user controls. For example, information (e.g., provided by the first device to the second device) associated with the request can be evaluated based on the user controls. Information associated with the request can comprise location information (e.g., store, geographic coordinate, geographic area), timing information (e.g., time of request), payment information (e.g., amount of funds transfer, account number, account holder credential), and/or the like. The second device can determine if the account is activated or deactivated based on the evaluation of the information (e.g., with respect to the user controls). If the account is determined to be activated, the response can comprise an authorization. If the account is determined to be deactivated, the response can comprise a denial of authorization.

At step 1010, the transaction can be processed based on the response. Processing the transaction based on the response can comprise denying the request based on the user controls, accepting the request based on the user controls, and/or the like. For example, if the response is an authorization, then the transaction can be completed (e.g., by transfer of funds). If the response is a denial of authorization, then the transaction can be terminated, another form of payment can be requested, and/or the like.

In an aspect, a notification can be provided to the account holder. The notification can be related to the denying of the request, acceptance of the request, and/or the like. The notification can be provided via a SMS message, email, paper mail, application notification, activation of an indicator (e.g., on a notification device, such as a key fob), and/or the like.

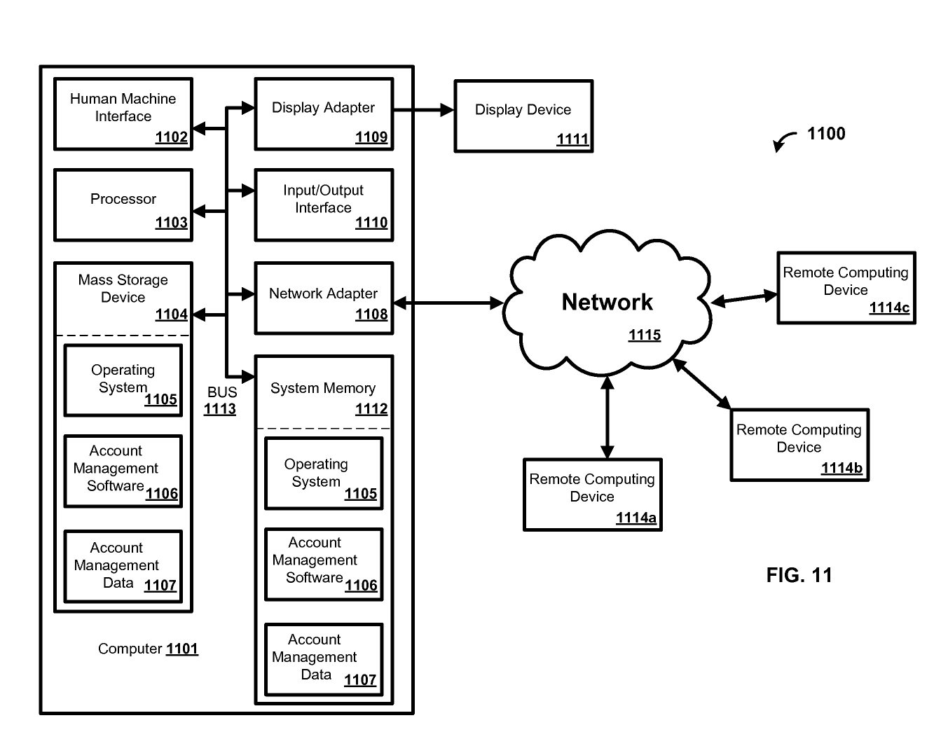

In an exemplary aspect, the methods and systems can be implemented on a computer 1101 as illustrated in FIG. 11 and described below. By way of example, the transaction device 102, first account device 108, second account device 110, and/or user device 122 of FIG. 1 can be computers as illustrated in FIG. 11. Similarly, the methods and systems disclosed can utilize one or more computers to perform one or more functions in one or more locations. FIG. 11 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 1101. The components of the computer 1101 can comprise, but are not limited to, one or more processors or processing units 1103, a system memory 1112, and a system bus 1113 that couples various system components including the processor 1103 to the system memory 1112. In the case of multiple processing units 1103, the system can utilize parallel computing.

The system bus 1113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and each of the subsystems, including the processor 1103, a mass storage device 1104, an operating system 1105, account management software 1106, account management data 1107, a network adapter 1108, system memory 1112, an Input/Output Interface 1110, a display adapter 1109, a display device 1111, and a human machine interface 1102, can be contained within one or more remote computing devices 1114a,b,c at physically separate locations, connected through buses of this form, in effect implementing a fully distributed system.

The computer 1101 typically comprises a variety of computer readable media. Exemplary readable media can be any available media that is accessible by the computer 1101 and comprises, for example and not meant to be limiting, both volatile and non-volatile media, removable and non-removable media. The system memory 1112 comprises computer readable media in the form of volatile memory, such as random access memory (RAM), and/or non-volatile memory, such as read only memory (ROM). The system memory 1112 typically contains data such as account management data 1107 and/or program modules such as operating system 1105 and account management software 1106 that are immediately accessible to and/or are presently operated on by the processing unit 1103.

In another aspect, the computer 1101 can also comprise other removable/non-removable, volatile/non-volatile computer storage media. By way of example, FIG. 11 illustrates a mass storage device 1104 which can provide non-volatile storage of computer code, computer readable instructions, data structures, program modules, and other data for the computer 1101. For example and not meant to be limiting, a mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, including by way of example, an operating system 1105 and account management software 1106. Each of the operating system 1105 and account management software 1106 (or some combination thereof) can comprise elements of the programming and the account management software 1106. Account management data 1107 can also be stored on the mass storage device 1104. Account management data 1107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 1101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 1103 via a human machine interface 1102 that is coupled to the system bus 1113, but can be connected by other interface and bus structures, such as a parallel port, game port, an IEEE 1394 Port (also known as a Firewire port), a serial port, or a universal serial bus (USB).

In yet another aspect, a display device 1111 can also be connected to the system bus 1113 via an interface, such as a display adapter 1109. It is contemplated that the computer 1101 can have more than one display adapter 1109 and the computer 1101 can have more than one display device 1111. For example, a display device can be a monitor, an LCD (Liquid Crystal Display), or a projector. In addition to the display device 1111, other output peripheral devices can comprise components such as speakers (not shown) and a printer (not shown) which can be connected to the computer 1101 via Input/Output Interface 1110. Any step and/or result of the methods can be output in any form to an output device. Such output can be any form of visual representation, including, but not limited to, textual, graphical, animation, audio, tactile, and the like. The display 1111 and computer 1101 can be part of one device, or separate devices.

The computer 1101 can operate in a networked environment using logical connections to one or more remote computing devices 1114a,b,c. By way of example, a remote computing device can be a personal computer, portable computer, smartphone, a server, a router, a network computer, a peer device or other common network node, and so on. Logical connections between the computer 1101 and a remote computing device 1114a,b,c can be made via a network 1115, such as a local area network (LAN) and/or a general wide area network (WAN). Such network connections can be through a network adapter 1108. A network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components reside at various times in different storage components of the computing device 1101, and are executed by the data processor(s) of the computer. An implementation of account management software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
manipulating an account, wherein the account is activated or deactivated based on user controls managed by an account holder of the account, wherein the account is deactivated by default;
receiving instructions for configuring the user controls from the account holder;
receiving a request to process a transaction based on the account; and
processing the request based on the user controls.

2. The method of claim 1, further comprising providing, to the account holder, an interface comprising inputs for configuring the user controls.

3. The method of claim 2, wherein the user controls control activation of the account based on at least one of a time limitation, a geospatial limitation, and a mathematical limitation.

4. The method of claim 1, wherein the user controls comprise a control configured to switch between activation and deactivation of the account.

5. The method of claim 1, wherein deactivation prevents disbursement of funds from the account.

6. The method of claim 1, wherein the processing the request comprises denying the request based on the user controls, and further comprising providing a notification to the account holder related to the denying of the request.

7. The method of claim 1, wherein the account is deactivated or activated based on at least one of an account flag associated with the user controls and evaluation of an authorization rule associated with the user controls.

8. A method, comprising:
receiving a request to process a transaction based on an account, wherein the account is activated or deactivated by user controls managed by an account holder of the account, and wherein the account is activated by default;
determining whether the account is activated or deactivated based on the user controls; and
denying or accepting the request based on the determination of whether the account is activated or deactivated.

9. The method of claim 8, further comprising providing, to the account holder, an interface comprising inputs for configuring the user controls.

10. The method of claim 9, wherein the user controls control activation of the account based on at least one of a time limitation, a geospatial limitation, and a mathematical limitation.

11. The method of claim 8, wherein the user controls comprise a control configured to switch between activation and deactivation of the account.

12. The method of claim 8, wherein deactivation prevents disbursement of funds from the account.

13. The method of claim 8, further comprising providing a notification to the account holder related to the denying or accepting of the request.

14. The method of claim 8, wherein the account is deactivated or activated based on at least one of an account flag associated with the user controls and evaluation of an authorization rule associated with the user controls.

15. A method, comprising:
receiving, at a first device, a request to process a transaction based on an account;
determining a second device configured to service the account, wherein the second device is configured to authorize or deny transfer of funds from the account based on user controls that activate or deactivate the account based on input from an account holder of the account, and wherein the account is deactivated by default;
requesting authorization, from the second device, to transfer funds from the account based on the transaction;
receiving, from the second device, a response to the request for authorization, wherein the response is based on the user controls; and
processing the transaction based on the response.

16. The method of claim 15, wherein the user controls are accessible by the account holder via an interface comprising inputs for configuring the user controls.

17. The method of claim 16, wherein the user controls control activation of the account based on at least one of a time limitation, a geospatial limitation, and a mathematical limitation.

18. The method of claim 15, wherein the user controls comprise a control configured to switch between activation and deactivation of the account.

19. The method of claim 15, wherein deactivation prevents disbursement of funds from the account.

20. The method of claim 15, wherein the processing the transaction based on the response comprises denying the request based on the user controls, and further comprising providing a notification to the account holder related to the denying of the request.
